(19) United States
(12) Patent Application Publication
(10) Pub. No.: US 2013/0246816 A1
(43) Pub. Date: Sep. 19, 2013

(54) POWER DISTRIBUTION UNIT AND METHOD USING A SINGLE INTERNET PROTOCOL ADDRESS TO CONTROL MULTIPLE POWER DISTRIBUTION UNITS

(71) Applicants: Hung-Ming HSIEH, Taipei (TW); Hung-Chun Chien, Taipei (TW); Wen-Shuo Chuang, Taipei (TW); Yung-Hao Peng, Taipei (TW)

(72) Inventors: Hung-Ming HSIEH, Taipei (TW); Hung-Chun Chien, Taipei (TW); Wen-Shuo Chuang, Taipei (TW); Yung-Hao Peng, Taipei (TW)

(21) Appl. No.: 13/423,473

(22) Filed: Mar. 19, 2012

(51) Int. Cl. G06F 1/26; G06F 3/01; G06F 15/16

(52) U.S. Cl. 713/310

(57) ABSTRACT

A power distribution unit (PDU) performs a method using a single IP address to control multiple PDUs and has a controller and at least one network port connected to the controller. The controller provides an html-based user interface for users to set up virtual outlets therethrough. When multiple foregoing PDUs are connected through a network, one of the PDUs can be logged in with an internet protocol (IP) address, and the outlets of other PDUs are virtualized as added outlets of the login PDU. Outlet information associated with the original and added outlets of the login PDU can be simultaneously displayed on the user interface of the login PDU. Accordingly, users can employ a single IP address to control the outlets of all the PDUs.

### BACKGROUND OF THE INVENTION

1. Field of the Invention

The present invention relates to a power distribution unit (PDU) and a method using a single internet protocol (IP) address to control multiple power distribution units, and more particularly to a power distribution unit and a method virtualizing outlets of at least one networked PDU as outlets of another networked PDU and using one IP address to control all the outlets of each networked PDU.

2. Description of the Related Art

PDUs have been extensively used for power management of information technology (IT) equipment for years. To cope with the demand of supplying power to a multitude of IT equipment or peripheral equipment, multiple rackmount PDUs are mounted on racks for mounting IT equipment to respectively provide multiple outlets for multiple IT equipment, such as servers, routers, firewalls and the like, or peripheral equipment, such as printers, displays, fax machines and the like, to be connected therewith, so as to supply power to the IT equipment or peripheral equipment. Each rackmount PDU is further connected to a corresponding uninterruptible power supply (UPS) system to simultaneously support the function of UPS. Conventional rackmount PDUs can be classified into basic rack PDUs, metered rack PDUs, switched rack PDUs and intelligent rack PDUs. Among them, the metered rack PDUs and the intelligent rack PDUs can be remotely powered on or off through a network.

Conventional PDUs may be 1 U or 2 U in height, and each conventional PDU roughly has 8 to 16 outlets, which is usually outnumbered by equipment on the racks. Hence, more PDUs are required as current technique supports up to 16 PDUs at most. As mentioned earlier, PDUs are characterized in remote control through a network. In other words, a control center connected to multiple PDUs needs to log in each PDU and further control each outlet on the PDU to power on or off equipment connected to the outlet. However, each PDU must have a dedicated IP address. If 16 PDUs are serially connected, 16 IP addresses are needed. To monitor or control each PDU, a correct IP address must be used to log in to a corresponding PDU. Memorizing 16 or more IP addresses turns out to be a challenging job to all managers.

To facilitate the control over PDU, PDUs are connected in a daisy chain configuration so that a physical line, normally RJ11/RJ45, is connected between PDUs. The connected PDUs are defined to have a master PDU and multiple slave PDUs, and the master PDU communicates with the slave PDUs through the daisy-chained physical lines. Thus, users just need to log in the master PDU and information of all the PDUs can be accessible so that one IP address is employed to manage all the connected PDUs.

As physical lines must be used to daisy chain all the PDUs, such requirement increases wiring difficulty in racks having complicated wiring. Distance limitation further worsens the feasibility of using physical lines to implement a daisy chain loop. Under the circumstance, all daisy-chained PDUs are connected as adjacent as possible, thereby lowering the flexibility in terms of mounting position of PDU. If space next to a PDU in a rack is occupied by other IT equipment, the equipment must be demounted and mounted to elsewhere to make space for a new PDU to be mounted. Moreover, the daisy-chained physical lines are at risk of being disconnected while there is no easy way for managers to identify where the disconnected line is located.

Besides the daisy chain connection, another solution is to set up a server and connect to PDUs through central control software in the server. The advantage lies in a single IP address used to centrally control all connected PDUs. The disadvantage lies in costly software packages required for network management, such as HP OpenView/IBM Tivoli and the like, which are not affordable to small to medium sized enterprises. Except an IT environment, other environments, such as production lines of factories, pond aeration systems, irrigation systems and lighting system for small sized agriculture, are not appropriate for setting up a server. Limited by the factors of cost and environment, the technique using software in a server to centrally control the connected PDUs has never prevailed.

### SUMMARY OF THE INVENTION

A first objective of the present invention is to provide a method using a single IP address to control multiple PDUs, which targets at virtualizing the outlets of at least one PDU as the added outlets of a login PDU so as to centrally control the outlets of multiple PDUs without costing a lot and being limited by the length limitation of physical line.

To achieve the foregoing objective, the method uses a single IP address to control multiple PDUs respectively having multiple outlets and connected to a network, is performed by one of the PDUs operated at a login mode and has steps of:

accepting to be logged in as a login PDU;

providing an html-based user interface to accept at least one PDU that is not logged in as at least one non-login PDU and virtualizing the outlets of the at least one non-login PDU as added outlets to the original outlets of the login PDU;

handshaking with each one of the at least one non-login PDU;

receiving outlet information from the at least one non-login PDU;

displaying the outlets of the login PDU and the at least one non-login PDU; and

accepting to control the displayed outlets.

The method allows users to select one of the PDUs connected to a network to be logged in with an IP address. The html-based user interface is used to display the outlets of the login PDU and virtualize the outlets of other PDUs not logged in as the added outlets to the original outlets of the login PDU. After handshaking with the virtualized PDUs, outlet information of the virtualized PDUs is transmitted to the login PDU and displayed on the user interface for user to issue a control command through the network to control one of the added outlets of the login PDU. Accordingly, the method uses a single IP address to centrally control the outlets of all the networked PDUs.

A second objective of the present invention is to provide a PDU, which targets at virtualizing the outlets of at least one PDU as the added outlets of a login PDU so as to centrally control the outlets of multiple PDUs through a user interface without costing a lot and being limited by the length limitation of physical line.

To achieve the foregoing objective, the power distribution unit (PDU) is selected from multiple PDUs connected to a network and performs the foregoing method using a single IP address to control the PDUs.

The PDU has multiple outlets, at least one network port and a controller. The outlets are adapted to be detachably connected with a power source. The controller is connected to each outlet and the at least one network port, is adapted to control the outlet to be detachably connected with the power source, and provides the html-based user interface having a virtual outlet setting page and an outlet display and control page.

The virtual outlet setting page is used to add other PDUs and virtualize the outlets of those PDUs as added outlets to the original outlets.

The outlet display and control page is used to display and control the outlets of all the PDUs.

The advantages of the present invention are as follows.

(1) Control multiple PDUs with one IP address: The present invention virtualizes the outlets of at least one PDU as the added outlets to the original outlets of a login PDU so that the login PDU can access the outlet information of all the PDUs. Hence, users just need to log in one of the PDUs with one IP address to centrally control the outlets of all the PDUs on a user interface of the login PDU.

(2) No length limitation of physical line: All the PDUs of the present invention are connected through network lines instead of daisy-chained physical lines. It is not necessary for all the PDUs to be adjacent to each other, thereby rending more flexibility in terms of the mounting and connection of the PDUs.

(3) No requirement on dedicated computer server and expensive central management software: All PDUs of the present invention can be operated under a regular protocol, and no dedicated computer server and central management software are required. Accordingly, operational cost can be effectively reduced.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a power distribution unit in accordance with the present invention;

FIG. 2 is a schematic view of a user interface of the power distribution unit in FIG. 1;

FIG. 3 is a schematic view of another user interface of the power distribution unit in FIG. 1;

FIG. 4 is a schematic view of a network architecture of the power distribution unit in FIG. 1;

FIG. 5 is a flow diagram of a login operation mode of a method using a single IP address to control multiple PDUs in accordance with the present invention; and

FIG. 6 is a flow diagram of a non-login operation mode of a method using a single IP address to control multiple PDUs in accordance with the present invention.

### DETAILED DESCRIPTION OF THE INVENTION

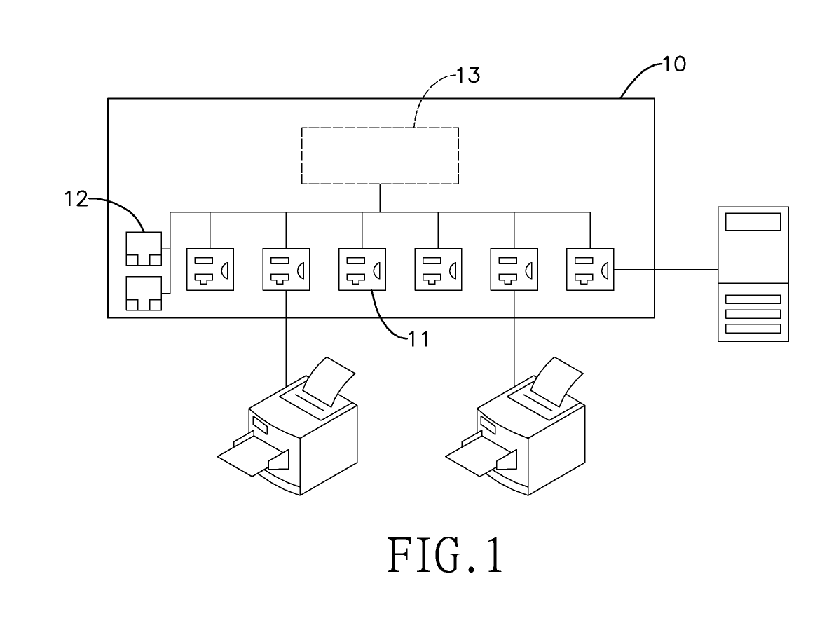

With reference to FIG. 1, a power distribution unit (PDU) 10 in accordance with the present invention has multiple outlets 11, at least one network port 12 and a controller 13. The outlets 11 and the at least one network port 12 are mounted on the PDU. Each outlet 11 has a power loop detachably connected with a power source. The controller 13 is connected to each outlet 11 and controls the power loop of the outlet 11 to power on or off. The network port 12 is connected to the controller 13 and an external network, and is based on a wireline protocol, such as Ethernet or the like, or a wireless protocol, such as WLAN, WIFI, ZIGBEE or the like.

The controller 13 has an html-based user interface for at least one computer to connect to and browse through a network complying with the wireline or wireless protocol. The user interface has a virtual outlet setting page 100 and an outlet display and control page 200 for performing a virtual outlet setting function.

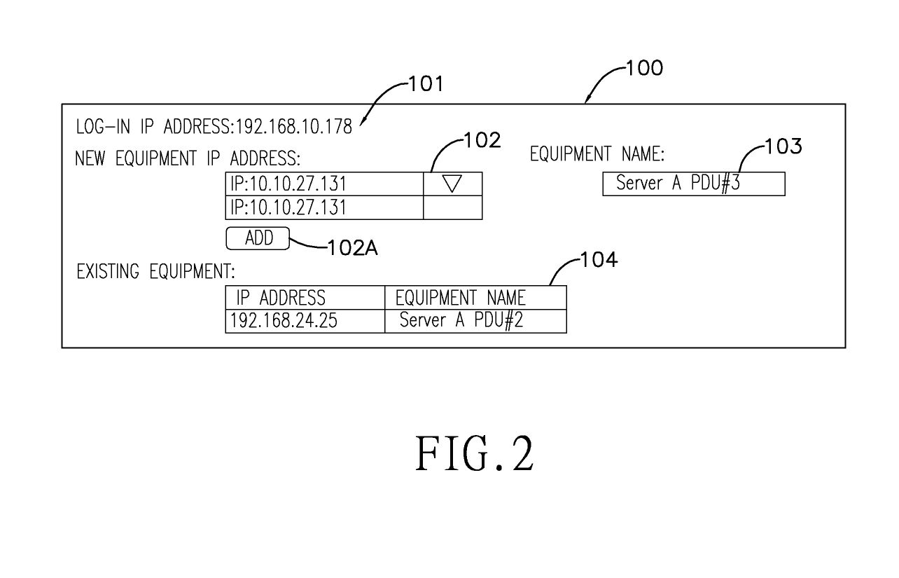

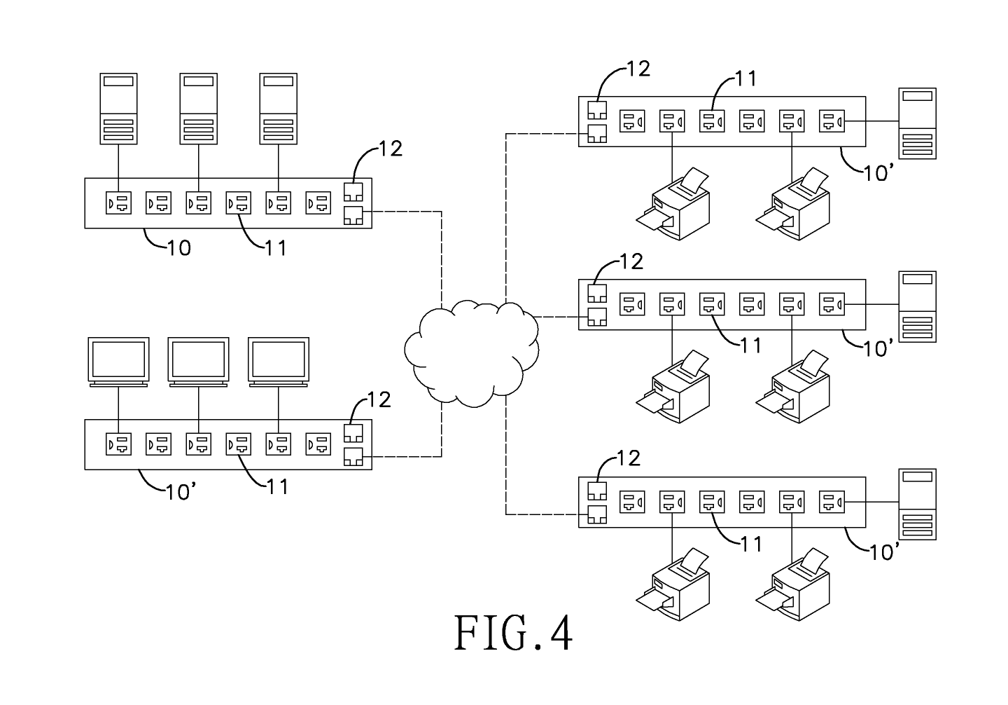

With reference to FIGS. 2 and 4, the virtual outlet setting page 100 has a login IP display column 101, a new equipment identification input column 102, an equipment name input column 103 and a current equipment display column 104.

The login IP display column 101 serves to display the IP address of the PDU 10 itself. When users log in with the IP address of the PDU 10 and enter the virtual outlet setting page 100, the IP address is displayed in the login IP display column 101.

The new equipment identification input column 102 further has an “add” button 102A. The new equipment identification input column 102 and the equipment name input column 103 serve for users to add another one of the PDUs 10′ and virtualize multiple outlets 11 of the added PDU 10′ as added outlets to the original outlets 11 of the PDU 10. The newly added PDU 10′ is structurally the same as the PDU 10 except that it is not logged in. The way of virtualizing the outlets 11 of the newly added PDU 10′ as added outlets to the original outlets 11 of the PDU 10 is to first enter identification information of the newly added PDU 10′ in the new equipment identification input column 102, further enter a name of the newly added PDU 10′ in the equipment name input column 103, and press the “add” button 102A to confirm the new addition. The identification information may be an IP address, a media access control (MAC) address or a serial number. In the present embodiment, the identification information is an IP address, that is, “10.10.27.131”, of a newly added PDU inputted in the new equipment identification input column 102. The PDU 10 further handshakes with the newly added PDU 10′ through the network and receives outlet information returned from the newly added PDU 10′ to virtualize the outlets 11 of the newly added PDU 10′ as added outlets to the original outlets 11 of the PDU 10 and add the newly added PDU 10′ to the current equipment display column 104 after the handshaking is completed. As all the newly added PDUs 10′ have identifiable MAC addresses and serial numbers, after connected to the network, the PDU 10 automatically searches all the newly added PDUs 10′ having the outlets 11 virtualized as added outlets to the original outlets 11 of the PDU 10 and displays a search result in the new equipment identification input column 102. The new equipment identification input column 102 is a drop-down list for users to directly click and select from.

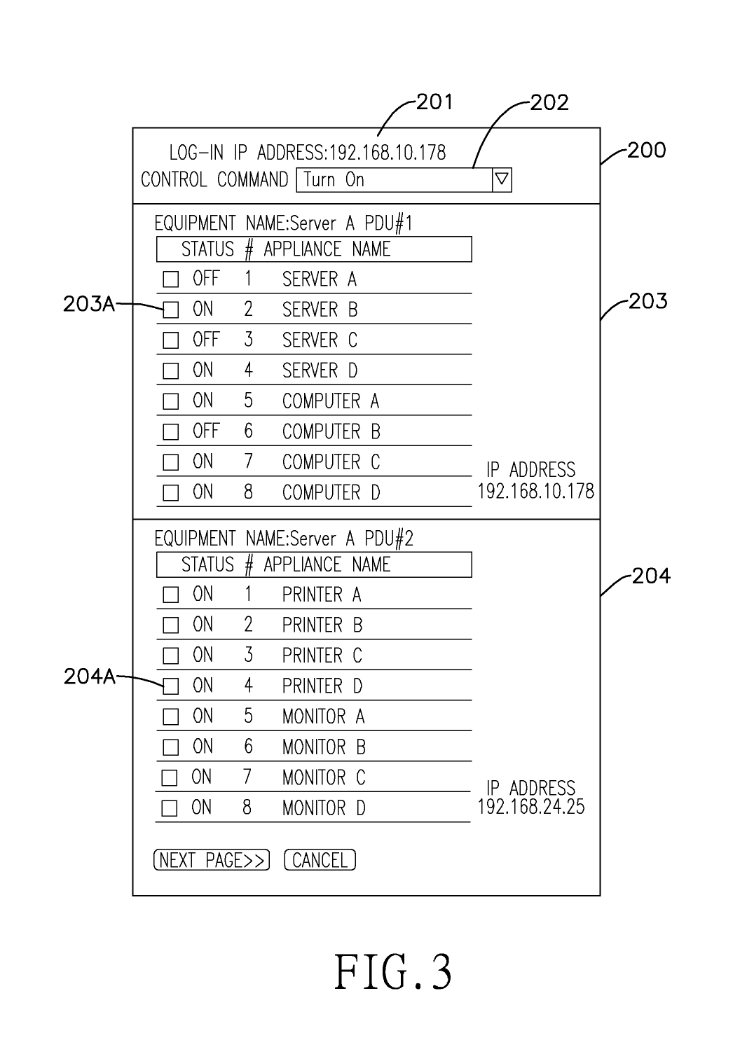

With reference to FIG. 3, the outlet display and control page 200 of the aforementioned user interface has a login IP display column 201, a control command selection column 202, an original outlet list 203 and at least one virtual outlet list 204.

The login IP display column 201 also displays the login IP address of the PDU 10. The control command selection column 202 serves for users to select an outlet control command, such as turn on, turn off, restart or the like, to be performed. The original outlet list 203 lists information pertinent to each outlet 11 of the PDU 10, such as an operation status (ON/OFF/RESTART), an outlet number (1˜8) and a name of equipment connected to the outlet 11 (servers A˜D and computers A˜D). Furthermore, the original outlet list 203 has a checkbox 203A for each outlet 11. When intending to vary the power state of the outlet 11, users can click on the checkbox 203A of the outlet 11 and then change the outlet control command in the control command selection column 202, and the newly selected outlet control command is sent to the controller for the controller to configure a new operation status, for example, changing from turn on to turn off or changing from turn off to restart.

Each one of the at least one virtual outlet list 204 is approximately the same as the original outlet list 203 except that different PDUs are displayed and controlled, and serves to display the outlet information of the newly added PDUs 10′. The outlets 11 of the newly added PDUs 10′ having the displayed outlet information have been virtualized as the outlets of the PDU 10. Although the outlets 11 of the newly added PDUs 10′ are virtualized as the outlets of the PDU 10, when handshaking with the PDU 10, the newly added PDUs 10′ transmit the outlet information to the PDU 10. Hence, the PDU 10 can display the outlet information of the newly added PDUs 10′ on the at least one virtual outlet list 204 of the outlet display and control page 200 associated with the PDU 10. The at least one virtual outlet list 204 lists the outlet information of the newly added PDUs 10′, including the operation statuses (ON/OFF/RESTART), the outlet numbers (1˜8) and the names of equipment connected to the outlet (printers A˜D and monitors A˜D). Furthermore, the virtual outlet list 204 has a checkbox 204A for each outlet. When intending to vary the power state of the outlet, users can click on the checkbox 204A of the outlet and then change the outlet control command in the control command selection column 202, and the newly selected outlet control command is sent to the controller for the controller to configure a new operation status.

With reference to FIG. 4, a network architecture of the power distribution unit in accordance with the present invention has multiple PDUs 10, 10′ connected to a network. The controller of each PDU 10, 10′ has a procedure stored therein and operated in a login mode or a non-login mode. The login mode is activated when a corresponding PDU 10, 10′ is logged in with an IP address. The non-login mode is activated when a corresponding PDU 10, 10′ is not logged in with an IP address. Suppose that the PDU 10 is the one logged in with an IP address, but the rest of PDUs 10′ are not logged in with an IP address. Therefore, the PDU 10 is operated under the login mode, and the rest of PDUs 10′ are operated under the non-login mode. Among all the PDUs 10, 10′, there is only one PDU 10 that is logged in with an IP address and operated under the login mode.

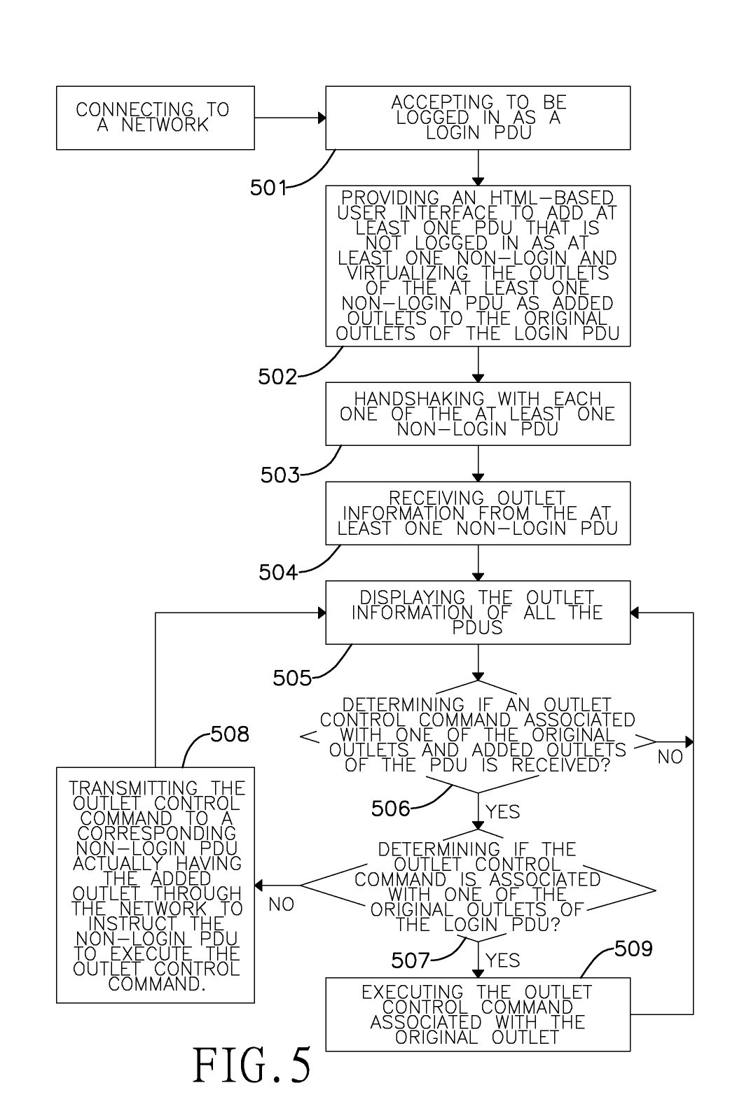

With reference to FIG. 5, after multiple PDUs 10, 10′ respectively having multiple outlets 11 are connected to a network, a method using a single IP address to control multiple outlets 11 in accordance with the present invention is performed by one of the PDUs 10 at a login mode and has the following steps.

Step 501: Accept to be logged in as a login PDU 10.

Step 502: Provide an html-based user interface to add at least one PDU 10′ that is not logged in as at least one non-login PDU 10′ and virtualize the outlets 11 of the at least one non-login PDU 10′ as added outlets to the original outlets 11 of the login PDU 10.

Step 503: Handshake with each one of the at least one non-login PDU 10′.

Step 504: Receive outlet information from the at least one non-login PDU′ 10′.

Step 505: Display the outlet information of all the PDUs 10, 10′.

Step 506: Determine if an outlet control command associated with one of the original outlets 11 and added outlets of the PDU 10 is received.

Step 507: Further determine if the outlet control command is associated with one of the original outlets 11 or the added outlets of the login PDU 10 after the outlet control command is inputted.

Step 508: If the outlet control command is associated with one of the added outlets of the login PDU 10, transmit the outlet control command to a corresponding non-login PDU 10′ actually having the added outlet through the network to instruct the non-login PDU 10′ to execute the outlet control command.

Step 509: If the outlet control command is associated with one of the original outlets 11 of the login PDU 10, execute the outlet control command associated with the original outlet 11.

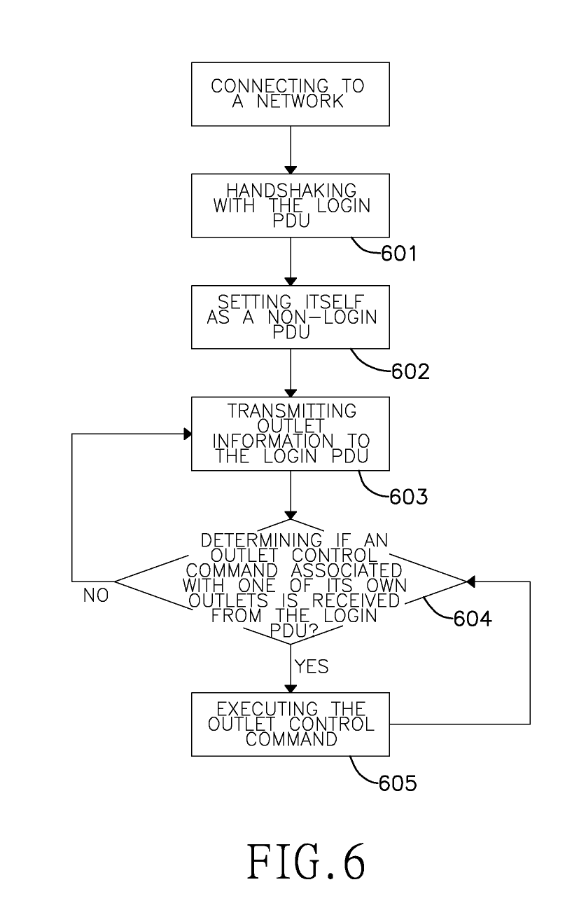

With reference to FIG. 6, after multiple PDUs 10, 10′ respectively having multiple outlets 11 are connected to a network, the method is performed by one of the PDUs 10′ at a non-login mode and has the following steps.

Step 601: Handshake with the login PDU 10.

Step 602: Set itself as a non-login PDU 10′.

Step 603: Transmit outlet information to the login PDU 10.

Step 604: Determine if an outlet control command associated with one of its own outlets 11 is received from the login PDU 10.

Step 605: If positive, execute the outlet control command, and if negative, return to Step 604.

The technical solution of the present invention targets at using one IP address to log in one of multiple PDUs 10 connected with a network and virtualizing the outlets 11 of other PDUs 10′ as added outlets to the original outlets 11 of the login PDU 10. Accordingly, users just need to log in one PDU 10 and all the outlets can be centrally monitored and controlled through a common user interface of the login PDU 10.

As any one of multiple networked PDUs can be selected as a login PDU 10 and the outlets 11 of the rest of PDUs 10′ can be virtualized as the added outlets to the original outlets 11 of the login PDU 10, a master-slave network platform is not a must. Since all PDUs 10, 10′ are connected and operated through network lines, no other physical lines are required. Accordingly, the PDU and method of the present invention provide more convenience and flexibility to users in terms of operation and maintenance and save the cost for purchasing network management software.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method using a single internet protocol (IP) address to control multiple power distribution units (PDUs) respectively having multiple outlets and connected to a network, the method performed by one of the PDUs operated at a login mode and comprising steps of:
accepting to be logged in as a login PDU;
providing an html-based user interface to accept at least one PDU that is not logged in as at least one non-login PDU and virtualizing the outlets of the at least one non-login PDU as added outlets to the original outlets of the login PDU;
handshaking with each one of the at least one non-login PDU;
receiving outlet information from the at least one non-login PDU;
displaying the outlets of the login PDU and the at least one non-login PDU; and
accepting to control the displayed outlets.

2. The method as claimed in claim 1, performed by the PDU operated at a non-login mode and further comprising steps of:
handshaking with the login PDU;
setting the PDU at the non-login mode as a non-login PDU; and
transmitting outlet information to the login PDU.

3. The method as claimed in claim 2, performed by the PDU operated at the login mode and further comprising steps of:
determining if an outlet control command associated with one of the original outlets and added outlets of the PDU is received;
further determining if the outlet control command is associated with one of the original outlets or the added outlets of the login PDU after the outlet control command is inputted;
if the outlet control command is associated with one of the original outlets of the login PDU, executing the outlet control command associated with the original outlet;
if the outlet control command is associated with one of the added outlets of the login PDU, transmitting the outlet control command to a corresponding non-login PDU actually having the added outlet through the network to instruct the non-login PDU to execute the outlet control command.

4. The method as claimed in claim 3, performed by the PDU operated at the non-login mode and further comprising steps of:
determining if an outlet control command associated with one of the outlets of the PDU at the non-login mode is received from the login PDU; and
if positive, executing the outlet control command.

5. A power distribution unit (PDU) selected from multiple PDUs connected to a network and performing a method using a single IP address to control the PDUs, each PDU comprising:
multiple outlets adapted to be detachably connected with a power source;
at least one network port; and
a controller connected to each outlet and the at least one network port, adapted to control the outlet to be detachably connected with the power source, and providing an html-based user interface having:
a virtual outlet setting page used to add other PDUs and virtualize the outlets of those PDUs as added outlets to the original outlets; and
an outlet display and control page used to display and control the outlets of all the PDUs;
the method performed at a login mode having steps of:
accepting to be logged in as a login PDU;
providing the html-based user interface to accept at least one PDU that is not logged in as at least one non-login PDU and virtualizing the outlets of the at least one non-login PDU as added outlets to the original outlets of the login PDU;
handshaking with each one of the at least one non-login PDU;
receiving outlet information from the at least one non-login PDU;
displaying the outlets of the login PDU and the at least one non-login PDU; and
accepting to control the displayed outlets.

6. The PDU as claimed in claim 5, wherein the method performed at a non-login mode further comprising steps of:
handshaking with the login PDU;
setting the PDU at the non-login mode as a non-login PDU; and
transmitting outlet information to the login PDU.

7. The PDU as claimed in claim 6, wherein the method performed at the login mode further comprising steps of:
determining if an outlet control command associated with one of the original outlets and added outlets of the PDU is received;
further determining if the outlet control command is associated with one of the original outlets or the added outlets of the login PDU after the outlet control command is inputted;
if the outlet control command is associated with one of the original outlets of the login PDU, executing the outlet control command associated with the original outlet; and
if the outlet control command is associated with one of the added outlets of the login PDU, transmitting the outlet control command to a corresponding non-login PDU actually having the added outlet through the network to instruct the non-login PDU to execute the outlet control command.

8. The PDU as claimed in claim 7, wherein the method performed at the non-login mode further comprising steps of:
handshaking with the login PDU;
setting the PDU at the non-login mode as a non-login PDU;
transmitting outlet information to the login PDU;
determining if an outlet control command associated with one of the outlets of the PDU at the non-login mode is received from the login PDU; and
if positive, executing the outlet control command.

9. The PDU as claimed in claim 5, wherein the virtual outlet setting page has:
a login IP display column used to display an IP address of the PDU;
a new equipment identification input column used to input identification information of the added PDUs having the outlets virtualized as added outlets to the original outlets;
an equipment name input column used to input a name of each of the added PDUs having the identification information; and
a current equipment display column used to display the identification information and the name of each of the added PDUs.

10. The PDU as claimed in claim 6, wherein the virtual outlet setting page has:
a login IP display column used to display an IP address of the PDU;
a new equipment identification input column used to input identification information of the added PDUs having the outlets virtualized as added outlets to the original outlets;
an equipment name input column used to input a name of each of the added PDUs having the identification information; and
a current equipment display column used to display the identification information and the name of each of the added PDUs.

11. The PDU as claimed in claim 7, wherein the virtual outlet setting page has:
a login IP display column used to display an IP address of the PDU;
a new equipment identification input column used to input identification information of the added PDUs having the outlets virtualized as added outlets to the original outlets;
an equipment name input column used to input a name of each of the added PDUs having the identification information; and
a current equipment display column used to display the identification information and the name of each of the added PDUs.

12. The PDU as claimed in claim 8, wherein the virtual outlet setting page has:
a login IP display column used to display an IP address of the PDU;
a new equipment identification input column used to input identification information of the added PDUs having the outlets virtualized as added outlets to the original outlets;
an equipment name input column used to input a name of each of the added PDUs having the identification information; and
a current equipment display column used to display the identification information and the name of each of the added PDUs.

13. The PDU as claimed in claim 9, wherein the outlet display and control page has:
a control command selection column used to select an outlet control command; and
an original outlet list listing information pertinent to each of the original outlets of the PDU and having a checkbox for each of the original outlets to be clicked and selected.

14. The PDU as claimed in claim 10, wherein the outlet display and control page has:
a control command selection column used to select an outlet control command; and
an original outlet list listing information pertinent to each of the original outlets of the PDU and having a checkbox for each of the original outlets to be clicked and selected.

15. The PDU as claimed in claim 11, wherein the outlet display and control page has:
a control command selection column used to select an outlet control command; and
an original outlet list listing information pertinent to each of the original outlets of the PDU and having a checkbox for each of the original outlets to be clicked and selected.

16. The PDU as claimed in claim 12, wherein the outlet display and control page has:
a control command selection column used to select an outlet control command.
an original outlet list listing information pertinent to each of the original outlets of the PDU and having a checkbox for each of the original outlets to be clicked and selected.

17. The PDU as claimed in claim 13, wherein the new equipment identification input column is a drop-down list displaying the newly added and automatically searched PDUs for users to directly click on and select from.

18. The PDU as claimed in claim 14, wherein the new equipment identification input column is a drop-down list displaying the newly added and automatically searched PDUs for users to directly click on and select from.

19. The PDU as claimed in claim 15, wherein the new equipment identification input column is a drop-down list displaying the newly added and automatically searched PDUs for users to directly click on and select from.

20. The PDU as claimed in claim 16, wherein the new equipment identification input column is a drop-down list displaying the newly added and automatically searched PDUs for users to directly click on and select from.

21. The PDU as claimed in claim 9, wherein the identification information is selected to be one of an IP address, a medium access control (MAC) address and a serial number.

22. The PDU as claimed in claim 10, wherein the identification information is selected to be one of an IP address, a medium access control (MAC) address and a serial number.

23. The PDU as claimed in claim 11, wherein the identification information is selected to be one of an IP address, a medium access control (MAC) address and a serial number.

24. The PDU as claimed in claim 12, wherein the identification information is selected to be one of an IP address, a medium access control (MAC) address and a serial number.

25. The PDU as claimed in claim 13, wherein the identification information is selected to be one of an IP address, a medium access control (MAC) address and a serial number.

26. The PDU as claimed in claim 14, wherein the identification information is selected to be one of an IP address, a medium access control (MAC) address and a serial number.

27. The PDU as claimed in claim 15, wherein the identification information is selected to be one of an IP address, a medium access control (MAC) address and a serial number.

28. The PDU as claimed in claim 16, wherein the identification information is selected to be one of an IP address, a medium access control (MAC) address and a serial number.

29. The PDU as claimed in claim 17, wherein the identification information is selected to be one of an IP address, a medium access control (MAC) address and a serial number.

30. The PDU as claimed in claim 18, wherein the identification information is selected to be one of an IP address, a medium access control (MAC) address and a serial number.

31. The PDU as claimed in claim 19, wherein the identification information is selected to be one of an IP address, a medium access control (MAC) address and a serial number.

32. The PDU as claimed in claim 20, wherein the identification information is selected to be one of an IP address, a medium access control (MAC) address and a serial number.

33. The PDU as claimed in claim 5, wherein the at least one network port complies with a wireline protocol or a wireless protocol.

34. The PDU as claimed in claim 6, wherein the at least one network port complies with a wireline protocol or a wireless protocol.

35. The PDU as claimed in claim 7, wherein the at least one network port complies with a wireline protocol or a wireless protocol.

36. The PDU as claimed in claim 8, wherein the at least one network port complies with a wireline protocol or a wireless protocol.

37. The PDU as claimed in claim 9, wherein the at least one network port complies with a wireline protocol or a wireless protocol.

38. The PDU as claimed in claim 10, wherein the at least one network port complies with a wireline protocol or a wireless protocol.

39. The PDU as claimed in claim 11, wherein the at least one network port complies with a wireline protocol or a wireless protocol.

40. The PDU as claimed in claim 12, wherein the at least one network port complies with a wireline protocol or a wireless protocol.

41. The PDU as claimed in claim 13, wherein the at least one network port complies with a wireline protocol or a wireless protocol.

42. The PDU as claimed in claim 14, wherein the at least one network port complies with a wireline protocol or a wireless protocol.

43. The PDU as claimed in claim 15, wherein the at least one network port complies with a wireline protocol or a wireless protocol.

44. The PDU as claimed in claim 16, wherein the at least one network port complies with a wireline protocol or a wireless protocol.

45. The PDU as claimed in claim 17, wherein the at least one network port complies with a wireline protocol or a wireless protocol.

46. The PDU as claimed in claim 18, wherein the at least one network port complies with a wireline protocol or a wireless protocol.

47. The PDU as claimed in claim 19, wherein the at least one network port complies with a wireline protocol or a wireless protocol.

48. The PDU as claimed in claim 20, wherein the at least one network port complies with a wireline protocol or a wireless protocol.
